(19) United States
(12) Patent Application Publication
(10) Pub. No.: US 2016/0055436 A1
(43) Pub. Date: Feb. 25, 2016

(54) DYNAMIC INNOVATION DRIVER

(71) Applicant: SAUDI BASIC INDUSTRIES CORPORATION, Riyadh (SA)

(72) Inventor: Zuhair Yasin Al-Taha, Jubail (SA)

(21) Appl. No.: 14/782,888

(22) PCT Filed: Apr. 8, 2014
(86) PCT No.: PCT/IB2014/060538

§ 371 Date: Oct. 7, 2015

Related U.S. Application Data
(60) Provisional application No. 61/811,289, filed on Apr. 12, 2013.

(51) Int. Cl. G06Q 10/06

(52) U.S. Cl. CPC G06Q 10/0637; G06Q 10/06398

(57) ABSTRACT

A dynamic innovation driver can include providing access to a database of items related to employee knowledge. Life cycle management of items in the database can be performed. The life cycle management can include receiving an item posted by an employee, assigning the item a status of draft, and facilitating a review of the item. The review of the item can result in the item being accepted or accepted based on input from at least one other employee. The participation by the employee in the posting and review of the items in the database can be tracked. Information about the participation may be provided to an employee assessment system.

### BACKGROUND

This disclosure generally relates to leveraging employee knowledge and, more particularly to providing a dynamic innovation driver.

Knowledge is one of the most important assets of any organization. The ability to capture and share knowledge, as well as the ability to reuse, reinvent and innovate using that knowledge is becoming increasingly important. Many enterprises have employee accessible repositories for sharing knowledge among employees. Employees generally have the ability to add items (e.g., articles, project summaries, test results) to the repository, to search for items in the repository using a variety of search criteria, and to retrieve items from the repository. This type of repository is often referred to as a knowledge database.

Employee participation in building and maintaining knowledge databases is important to keeping the information in the databases current. Employee participation is also important to keeping the information in the databases relevant to the employees. Employees are typically resistant to taking on the task of updating a knowledge database, particularly when it is seen as a task that is not related to the successful completion of a current work project or as a task whose completion does not directly benefit the employee. The lack of incentives to update the knowledge database often results in a knowledge database that is stagnant and that does not include the latest knowledge available for aiding employees in performing their work tasks in a more efficient manner.

There continues to be a need in the art for collecting and sharing knowledge among employees in an organization in a manner that is integrated into the work process and the employee evaluation process.

### BRIEF DESCRIPTION

Disclosed herein is a dynamic innovation driver.

In an embodiment a method, computer program product, or a system can provide access to a database of items related to employee knowledge. Life cycle management of items in the database can be performed. The life cycle management can include receiving an item posted by an employee, assigning the item a status of draft, and facilitating a review of the item. The review of the item can result in the item being accepted or not being accepted based on input from at least one other employee. The participation by the employee and the other employee in the posting and review of the items in the database can be tracked. Information about the participation can be provided to an employee assessment system.

In another embodiment, a method can include receiving information about employee participation in posting and supplementing items in a dynamic knowledge database. The supplementing items can include adding comments. The method can also include calculating a score for an employee based on the received information and on performance metrics for the employee. The performance metrics can include a component for measuring a number of items posted by the employee and a number of comments added by the employee to items posted by other employees. The method can further include comparing the calculated score to a target score for the employee, and outputting results of the comparing to an employee recognition system.

These and other non-limiting features and characteristics are more particularly described below.

### BRIEF DESCRIPTION OF THE DRAWINGS

Refer now to the figures, which are exemplary embodiments, and wherein the like elements are numbered alike.

FIG. 1 is an example of functions that can performed by an innovation driver system.

FIG. 2 is an example of a process flow implemented by an innovation driver system to move a knowledge database item through life cycle stages.

FIG. 3, including FIGS. 3A and 3B taken together, is an example of a user interface for entering an item into the knowledge database.

FIG. 4 is an example of a knowledge database and a key performance indicator database.

FIG. 5 is an example of key performance indicators and scoring criteria for an employee, a department, and a division.

FIG. 6 is an example of a process flow implemented by an innovation driver system to evaluate employees based on their contribution to the knowledge database.

FIG. 7 is an example of a user interface for displaying key performance metric indicators.

FIG. 8 is an example of evaluation criteria for best practices and success stories.

FIG. 9 is an example of an evaluation form for best practices and success stories.

FIG. 10 is an example of innovation awards and recognition.

FIG. 11 is an example of criteria for innovation recognition based on commercial impact and novelty.

FIG. 12 is an example of a computer system for implementing an innovation driver system.

### DETAILED DESCRIPTION

An embodiment provides an innovation driver system that can encourage the sharing and exchanging of knowledge between employees. The innovation driver system can include a knowledge repository for storing items such as employee ideas, articles, best practices, and success stories. The innovation driver system can also include software that facilitates moving the items in the repository through life cycle stages that include posting into the system, review, acceptance and monitoring. In addition, the innovation driver system can provide a tool for measuring employee participation (e.g., through scoring criteria) in building the repository by tracking how many items, types of items, status of items (e.g., applied, not applied), and comments about items are attributed to each employee. This data can be used as input to employee performance reviews and employee recognition. The performance measurements can also be set and tracked at department and division levels.

The innovation driver system can be used to create a dynamic culture of innovation among all employees by encouraging creativity. This is contrasted with the static nature of contemporary knowledge databases where data is not always entered and data that is entered may not be timely or relevant.

An embodiment of the innovation driver system allows all levels of innovation to be measured through a new way of scoring and recognizing participation in building the knowledge repository. The scoring can be aimed at different levels including, but not limited to, employees, a group of employees in a department, and a group of departments in a division. An online dashboard can be used for reporting to provide online monitoring and increased competition to meet scoring goals.

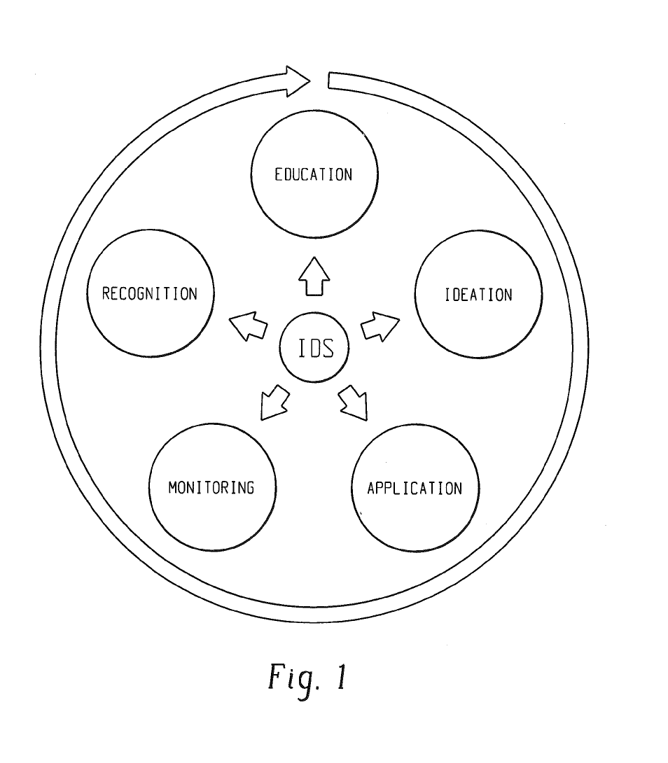

Turning now to FIG. 1, a block diagram of the major functions that can be performed by an embodiment of the innovation driver system is generally shown. The innovation driver system can be used to aid employees in ideation (i.e., the creative process of generating, developing, and communicating new ideas) by providing a database and user interfaces for storing the ideas and a framework for moving the items in the database through a life cycle process. In addition, the innovation driver system can be used to support education by providing a searchable repository of knowledge information. The innovation driver system can also aid in providing recognition to employees for participating in idea generation. Further, the innovation driver system can track an idea in the knowledge database through application and can monitor items in the knowledge database. The monitoring can result also in the item being reconsidered for application, be given a status of invalid because it is no longer relevant, or in extreme cases dropped from the database.

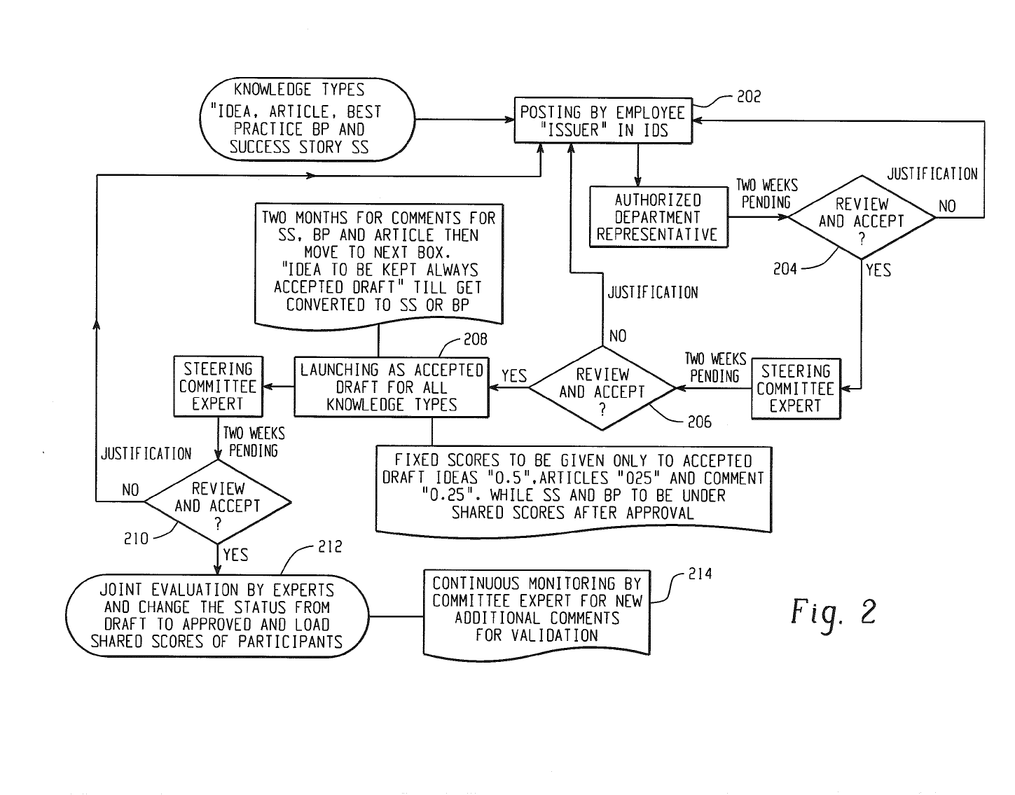

Turning now to FIG. 2, a process flow that can be performed by the innovation driver system is generally shown in accordance with an embodiment. At block 202, an employee (also referred to as an “issuer”) can post an item to the knowledge database that has to do with an idea, an article, a best practice, and/or a success story. Processing can continue at block 204 where an authorized department representative (e.g., a manager of the employee's department) reviews the posted item (suggested time is within two weeks) and either accepts or rejects the item. If the item is rejected, the authorized representative can document a justification for the rejection and processing can continue at block 202 where the employee can repost the item after addressing the reasons for rejection. If the item is accepted at block 204, then processing can continue at block 206 where a steering committee expert (e.g., in an area based on the subject/content of the item) can review the item within a suggested time of two weeks.

The steering committee expert can either accept or reject the item at block 206. If the item is rejected, then the steering committee expert can document a justification for the rejection and processing can continue at block 202 where the employee can repost the item after addressing the reasons for rejection. If the item is accepted at block 206, then processing can continue at block 208, and the item can be launched as an accepted draft for all types of knowledge (e.g., idea, an article, a best practice, and a success story) and can be awarded fixed points, in this example, only for ideas and articles. In this example, success stories and best practices can be treated separately with points being awarded and shared by participants after final approval at block 212. An idea can always be kept in an accepted draft position until it is converted to “applied” (e.g., the ideas has been applied to a business or technical problem), while success stories, best practices and articles can remain as accepted draft items for a suggested time of two months before their validity is reasserted at block 214.

When the status of the item has been set to “accepted draft” at block 208 and the two months have passed, processing can continue at block 210 and the item can be sent to a steering committee expert for review. The steering committee expert can either accept or reject the item at block 210. If the item is not accepted (i.e., it is rejected), then the steering committee expert can document a justification for the rejection and processing can continue at block 202 where the employee can repost the item after addressing the reasons for rejection. If the item is “accepted” at block 210, then processing can continue at block 212 where the status of the item can be changed to “approved” after joint evaluation from steering committee experts and shared points can be awarded to the participant employees and stored in a key performance indicator database. In an embodiment, a minimum number of experts (e.g., five, seven) can be specified for approving an item. Once the status of the item is “approved”, a steering committee expert can continue to monitor the item for new additional comments and validation at block 214. The monitoring can result, for example, in an applied idea success story, best practice and/or article being changed in terms of improvement or the items to be marked as invalid or for additional material to be added to the idea (e.g., attach a presentation). Items can be marked as invalid when they are determined to be incorrect or no longer useful. Marking an item as invalid and leaving it in the database allows the item to be revisited at a later date. The monitoring can result in additional points being awarded to employees through points from comments.

The categories of items can be modified based on implementation requirements and are not limited to ideas, articles, best practices and success stories as described herein when discussing exemplary embodiments. In addition, the processing shown in FIG. 2 can be modified based on implementation requirements to support a lifecycle with different checkpoints and/or time frames.

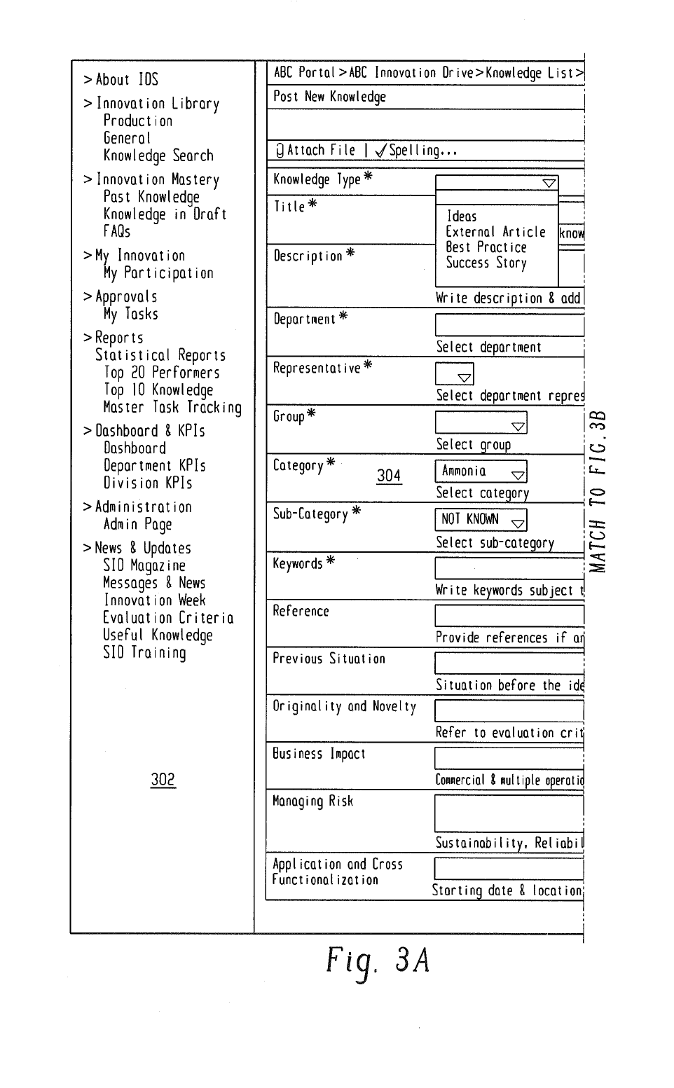

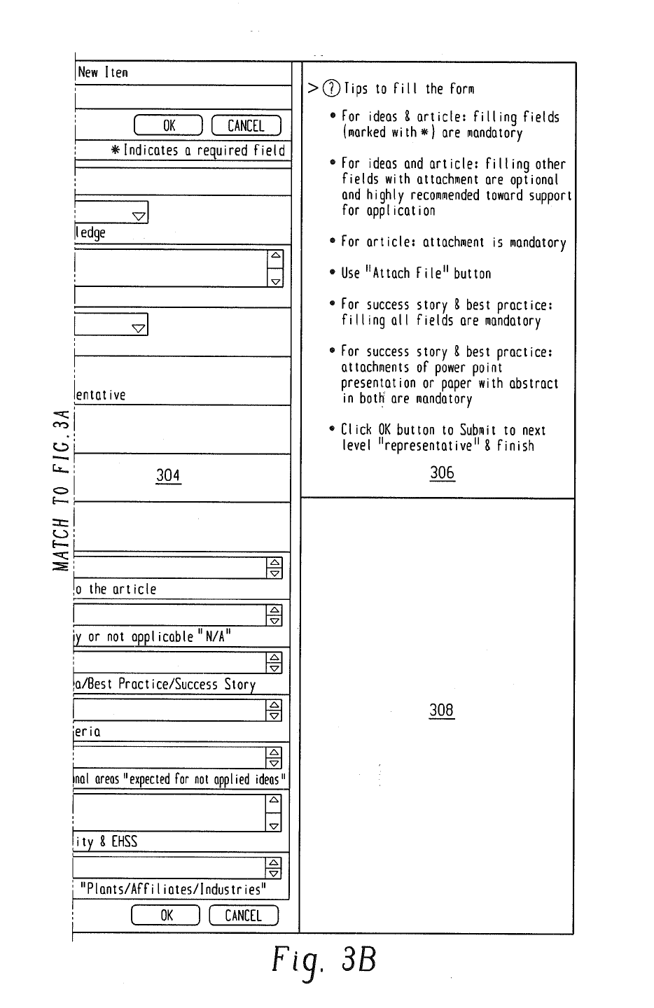

FIG. 3 is an example of a user interface for entering an item into the knowledge database. The user interface screen shown in FIG. 3 includes a menu section 302, a data entry section 304, a tips section 306, and a customizable section 308. The menu section 302 can include menu options such as innovation library (to review items in the knowledge database), innovation mastery (items that the user is involved in posting, my innovations (tracks the users scores and history), my innovations, approvals (items waiting for the approval of the line processor), reports, key performance indicators, administration, news and updates, and ISD training. The data entry section 304 can include data entry fields for posting a new item to the knowledge database. The data entry fields can be set up to receive free form text (that may be range verified) or set up to receive a selection from a drop down menu. The tips section 306 can include information related to the specific task being performed by the user in the data entry section 304. The customizable section 308 is blank in the user interface screen shown in FIG. 3 but it can include data such as, but not limited to, management messages, and employee/department/division performance information (e.g., top innovator and current score) as in, for example, a magazine page. In an embodiment, the user interface will not accept a best practice and/or a success story without a presentation (e.g., an abstract, a power point, a word document) being attached to the posting. The attachment can be modified as the item moves through the life cycle stages shown, for example, in FIG. 2. This provides material for the evaluation process described herein as well as material that can be pulled from the knowledge database 402 for use in presentations or articles or ideas for patent submissions.

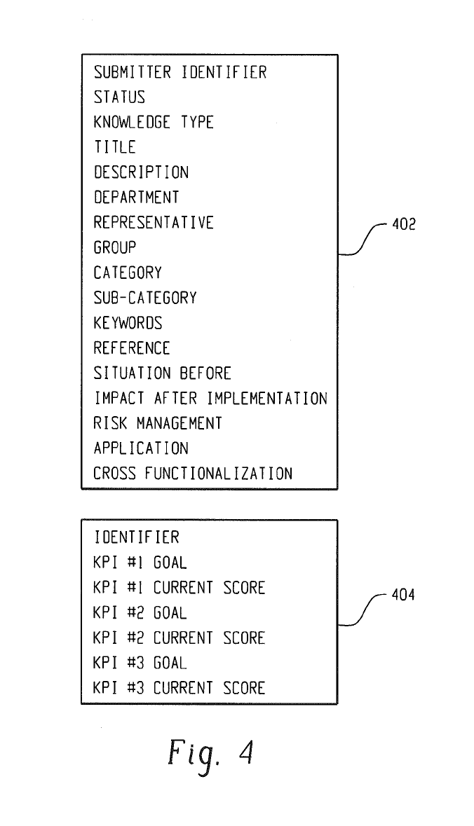

Turning now to FIG. 4, contents of a knowledge item database 402 and a key performance indicator database 404 are generally shown in accordance with an embodiment. The knowledge item database 402 and the key performance indicator database 404 can be stored in any storage format that supports the types of updates and accesses described herein (e.g., a relational database format, and a file system format). The knowledge item database 402 shown in FIG. 4 includes fields for a submitter identifier (e.g., employee identifier), a status (e.g., draft, approved), a knowledge type (e.g., idea, article, best practice, success story), a title, a description, a department (e.g., the employee department), a representative (e.g., a manager of the department), a group (e.g., where the item applies), a category (e.g., of the item), a sub-category (e.g., of the item), keywords associated with the item, references, situation before, originality, business impact after implementation, managing risk, application and cross functionalization.

The key performance indicator database 404 shown in FIG. 4 includes fields for an identifier (e.g., employee identifier, department identifier, division identifier), and three sets of key performance indicator goals and current scores. In an embodiment, key performance indicators that are set at the employee, department, and division level are stored in the key performance indicator database 404.

The contents of knowledge item database 402 and the key performance indicator database 404 can be modified based on implementation requirements and are not limited to fields in the embodiments shown in FIG. 4.

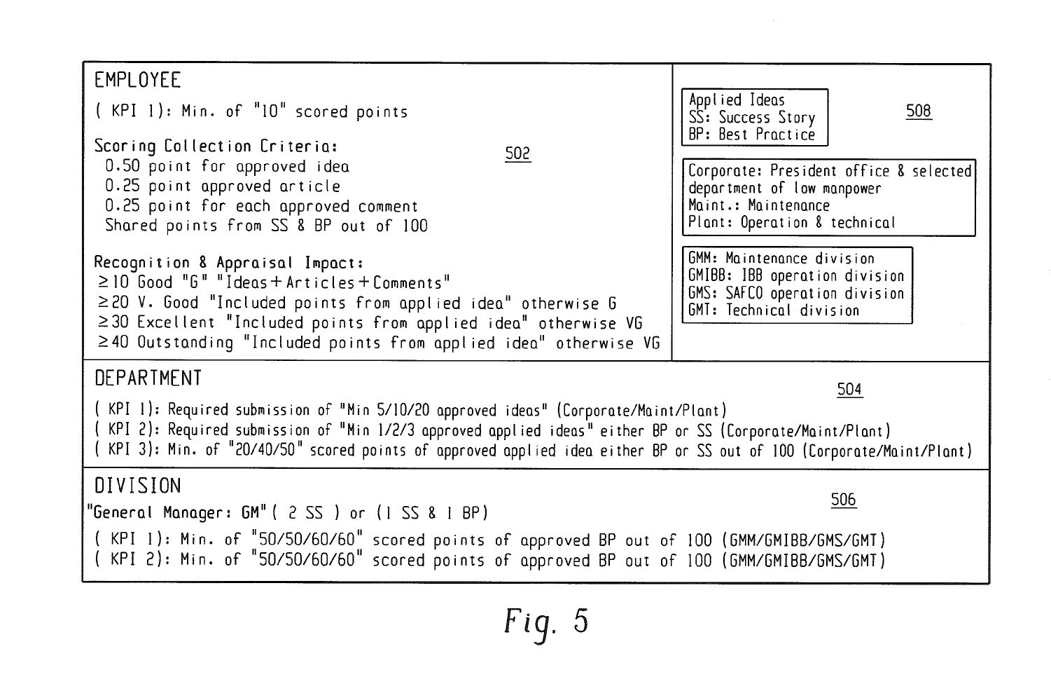

Turning now to FIG. 5, key performance indicators and scoring criteria for an employee 502, a department 504, and a division 506 according to an embodiment are generally shown. Also shown in FIG. 5 is a legend 508. The key performance indicators and scoring criteria shown in FIG. 5 can be implemented by an embodiment of the innovation driver system.

One key performance indicator for the employee is shown in FIG. 5 along with the scoring collection criteria, and the recognition and appraisal impact. The employee key performance indicator (also referred to herein as a “performance metric”) shown in FIG. 5 specifies a minimum point score of 10 (also referred to herein as a “target score”), where the employee receives 0.5 points for an approved idea, 0.25 points for an approved article, 0.25 points for each approved comment, and a variable number of shared points from a success story or best practice. For the purposes of employee evaluation and recognition, the performance metrics can specify that a score of 10-19 translates into a rating of “good” if it includes approved ideas, articles and comments; a score of 20-29 translates into a rating of “very good” if it includes at least one applied idea along with the criteria for a rating of good; a score of 30-39 translates into a rating of “excellent” if it includes at least one applied idea along with the criteria for a rating of good; and a score of greater than 40 translates into a rating of “outstanding” if it includes at least one applied idea along with the criteria for a rating of good. The requirements for each rating can be modified based on the job description of a particular employee and/or based on behaviors that the corporation is trying to encourage. These metrics and resulting scores can be tracked in the key performance indicator database 404.

As shown in FIG. 5, a department can have three key performance indicators that include a submission of a minimum number of approved ideas from employees in the department, a submission of a minimum number of approved applied ideas (either success stories or best practice), and a minimum number of points scored for the approved applied ideas (e.g., based on an steering committee assessment of a point value out of a total of 100 points). Also as shown in FIG. 5, a division can have key performance indicators that include a minimum number of points scored for approved success stories and best practices entered in the knowledge database. These key performance indicators can be modified based on the goals of particular departments and divisions.

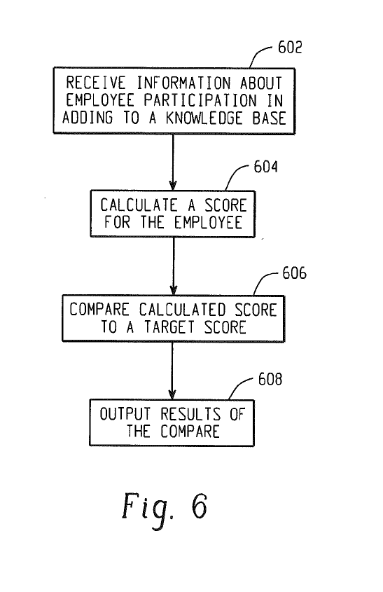

FIG. 6 is an example of a process flow implemented by the innovation driver system to evaluate employees based on their contribution to the knowledge database. At block 602, information can be received about employee participation in posting and supplementing items in a dynamic knowledge database. Supplementing items can include adding comments (or other additional information) to an existing item in the knowledge database. The information about the participation can include a number of items posted by the employee, a type of each of the items posted by the employee, a status of each of the items posted by the employee, and/or an amount of supplementing provided by the employee to items not posted by the employee. A score can be calculated, at block 604, for an employee based on the received information and on performance metrics for the employee. The performance metrics can include a component for measuring a number of items posted by the employee and a number of comments added by the employee to items posted by other employees. The calculated score can be compared, at block 606, to a target score for the employee and the results can be output, at block 608, to an employee recognition system. The results can also be output to an employee evaluation system.

The received information can also include information about multiple employees associated with a department. A score can be calculated for the department based on the received information and on performance metrics for the department. The calculated score for the department can them be compared to a target score for the department and then output.

The performance metrics and the target scores can be modified at any time, by an authorized user via one or more user interface screens.

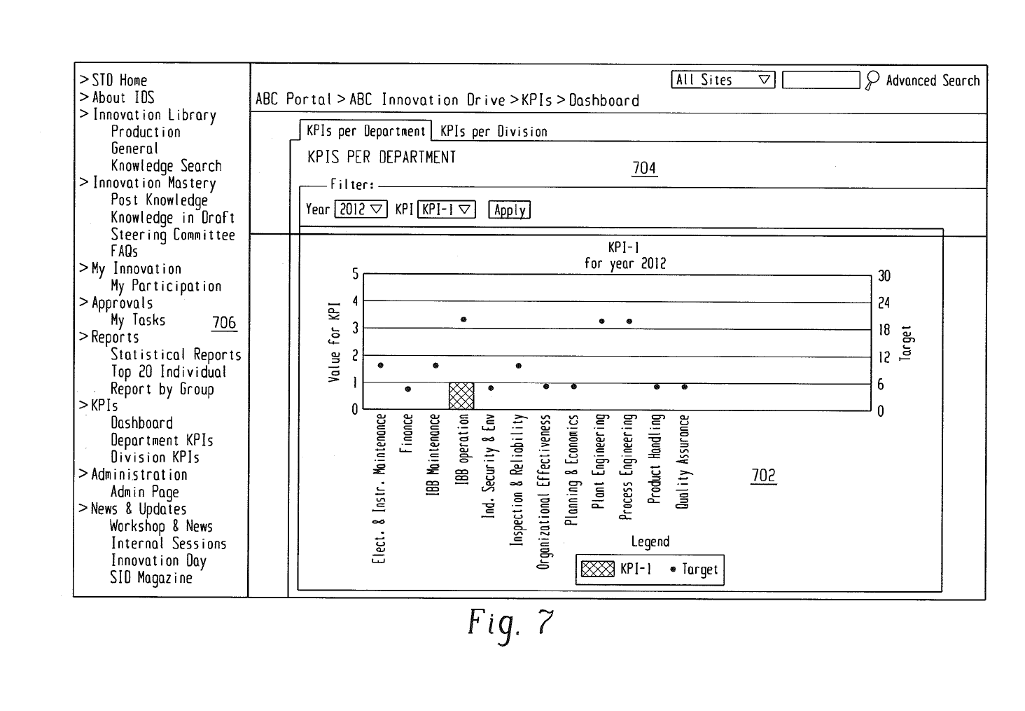

Turning now to FIG. 7, a user interface for displaying key performance metric indicators in accordance with an embodiment innovation driver system is generally shown. The user interface screen shown in FIG. 7 includes a menu section 706 (similar to the menu section 302 in FIG. 3), a data entry section 70, and a display section 702. The data entry section 704 can include a user input screen for selecting filters for selecting particular key performance indicator date ranges and departments. The display section 702 can display a graph as shown in FIG. 7 which shows current department scores compared to target department scores.

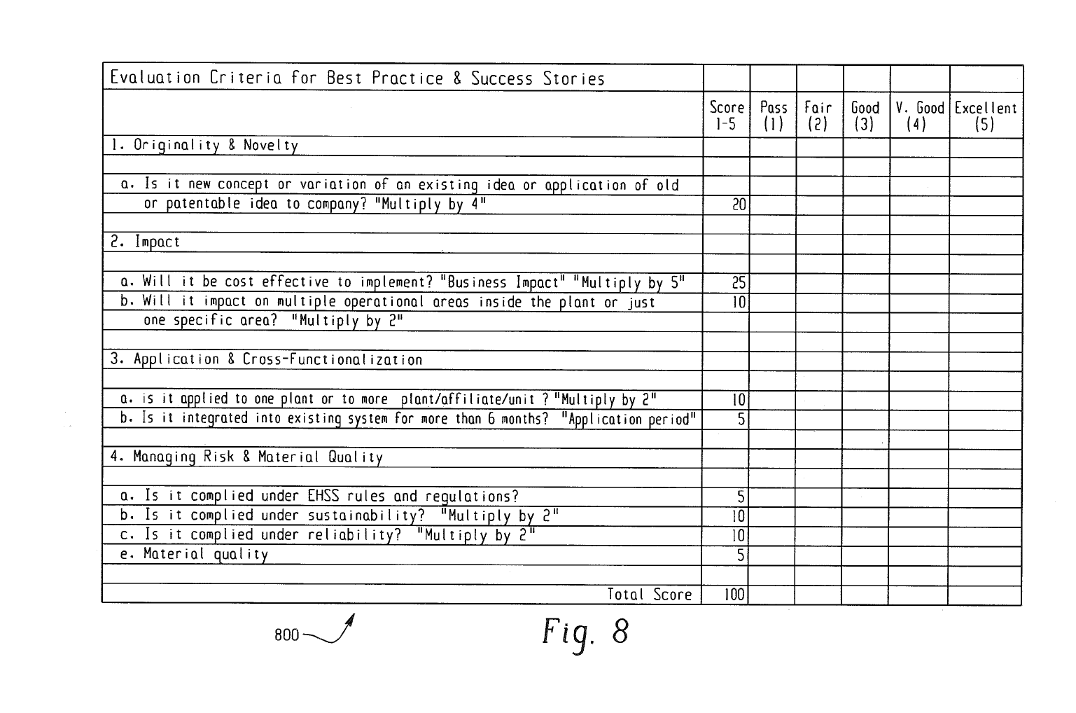

Turning now to FIG. 8, evaluation criteria 800 for best practices and success stories that can be implemented by the innovation driver system in accordance with an embodiment is generally shown. As shown in FIG. 8, evaluation criteria 808 can include originality and novelty. A score of 1-5 can be given based on whether it is a new concept or a variation on an existing idea, or an application of an old idea or a patentable idea. The score for originality and novelty can then be multiplied by 4 as shown in FIG. 8. FIG. 8 also shows criteria such as impact, application and cross functionalization, and managing risks and material quality.

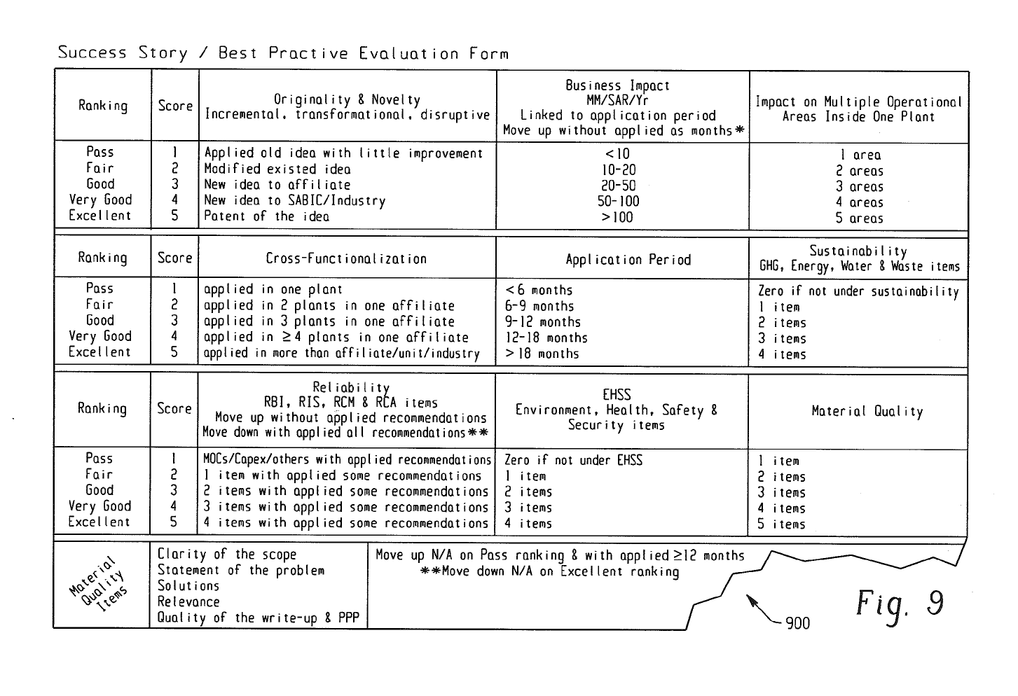

Turning now to FIG. 9, an evaluation form 900 for best practices and success stories that can be implemented by the innovation driver system in accordance with an embodiment is generally shown. The evaluation form 900 shown in FIG. 9 can be used to encourage long term improvements by giving more points for best practices and success stories that have longer term impacts. The evaluation form 900 shown in FIG. 9 can be modified (e.g., categories added, categories removed, categories combined, different scores assigned to the rankings) based on employee, department and division goals and behaviors to be encouraged.

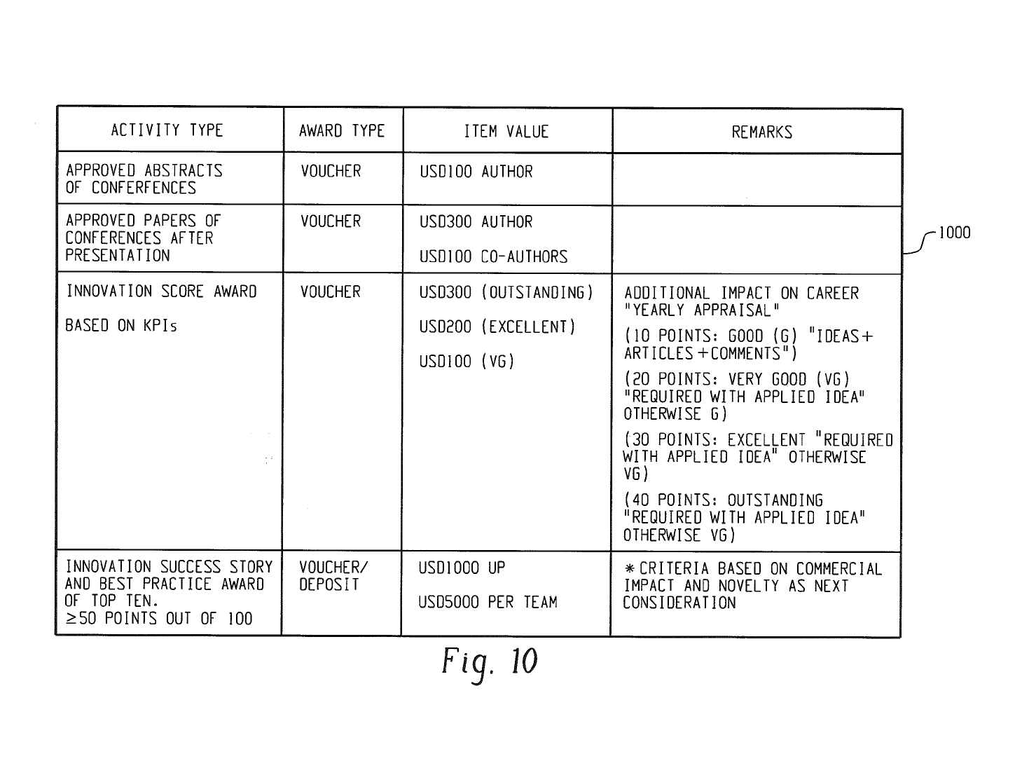

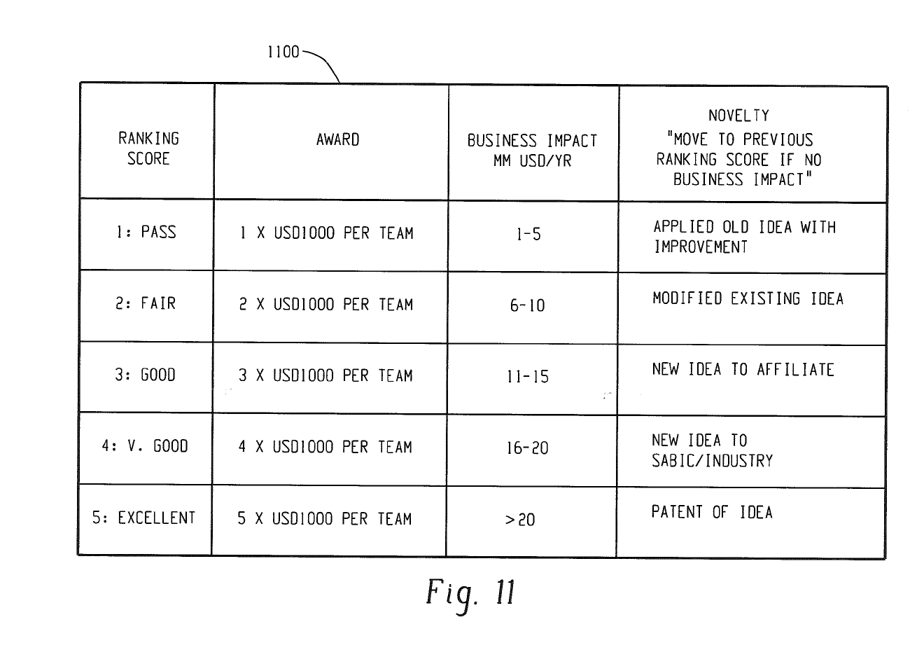

Turning now to FIG. 10, a chart 1000 of innovation awards and recognition activities that can be implemented by the innovation driver system in accordance with an embodiment is generally shown. The awards and recognition shown in chart 1000 provide both immediate rewards (e.g., a voucher, money) and longer term or career rewards (e.g., impacts on employee appraisal). Turning now to FIG. 11, a chart 1100 of criteria for innovation recognition based on commercial impact and novelty that can be implemented by the innovation driver system in accordance with an embodiment is generally shown. Both the chart 1000 shown in FIG. 10 and the chart 1100 shown in FIG. 11 can be modified based on employee and/or implementation requirements.

Embodiments of the innovation driver system can also be used to locate employees with knowledge in particular areas, based, for example, on areas where particular employees are active in posting items into the knowledge database 402.

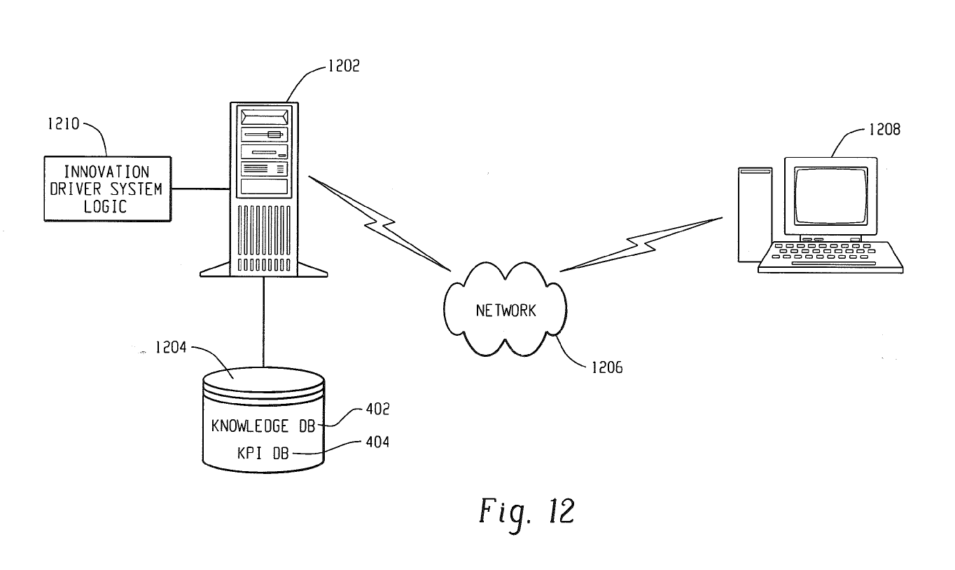

Turning now to FIG. 12, a computer system upon which an innovation driver system can be implemented will now be described in an exemplary embodiment. The computer system shown in FIG. 12 includes a host system 1202 and one or more user systems 1208. The user system 1208 and host system 1202 are communicatively coupled to one another via one or more networks 1206. The host system 1202 can be implemented as a high-speed computer processing device (e.g., a mainframe computer) capable of handling a high volume of activities conducted by innovation driver system logic 1210 and the user system 1208 with regard to the host system 1202. The host system 1202 can be operated by an enterprise or organization implementing the exemplary innovation driver system logic 1210 described herein. The host system 1202 can operate as a web server including a web site for providing access to the innovation driver system logic 1210.

The host system 1202 can also operate as an application server including one or more applications for providing the innovation driver system described herein. These one or more applications are collectively referred to herein as the innovation driver system logic 1210. The innovation driver system logic 1210 can include logic for performing the processing described above in FIGS. 2 and 6. In an embodiment, the host system 1202 is communicatively coupled to a storage device 1204, which can store a knowledge database, a key performance indicator database, as well as related data used to facilitate the innovation driver system.

While the storage device 1204 is shown in FIG. 12 as a separate physical device from the host system 1202, it will be understood that the storage device 1204 can be integrated into the host system 1202 as internal storage (e.g., as a hard disk drive), or accessed by the host system 1202 via the network.

The user device 1208 can be any type of communications device capable of sending and receiving information over a network. For example, the user device 1208 can be a general desktop computer or laptop, or can be a wireless device, such as a smart phone or personal digital assistant. The user device 1208 can be operated by a user of the innovation driver system. In an embodiment, one or more of the user devices 1208 can be directly attached to the host system 1202.

The networks 1206 can be any type of known networks in the art. For example, the networks 1206 can be a combination of public (e.g., Internet), private (e.g., local area network, wide area network, virtual private network), and can include wireless and wireline transmission systems (e.g., satellite, cellular network, terrestrial networks, etc.).

In an embodiment, the innovation driver system logic 1210 can be distributed across multiple processors, for example, in the host system 1202 and one or more user devices 1208.

Technical effects of embodiments include the ability to create and enhance a culture of ease in obtaining knowledge from employees, and to recognize employees for contributing to the collection of knowledge. A library of success stories, best practices, new ideas, articles, and shared comments can be collected and organized for easy access. The innovation driver system can provide a mastery of knowledge center for reporting the best approaches, and can aid employees in learning from each other even when they work in different geographic locations. The innovation driver system can also provide a report of individual participation as tracked in an innovation CV and can better identify experts in particular areas. In addition, the innovation driver system can be flexible for growth and expansion.

Set forth below are some embodiments of methods for dynamically driving innovation, computer program products for dynamically driving innovation, and systems for dynamically driving innovation.

### Embodiment 1

A method for dynamically driving innovation, the method comprising providing access to a database of items related to employee knowledge, and performing life cycle management of items in the database. The performing life cycle management includes receiving an item posted by an employee, assigning the item a status of draft, and facilitating a review of the item. The review results in the item being accepted or not-accepted based on input from at least one other employee. The method also comprises tracking participation by the employee and the at least one other employee in the posting and review of the items in the database. The method further comprises providing information about the participation to an employee assessment system.

### Embodiment 2

The method of Embodiment 1, wherein the at least one other employee is at least one of a manager of the employee and a steering committee expert.

### Embodiment 3

The method of any of Embodiments 1-2, wherein the items in the database include a description of an idea.

### Embodiment 4

The method of any of Embodiments 1-3, wherein the items in the database include at least one of an article, a description of a best practice, and a description of a success story.

### Embodiment 5

The method of any of Embodiments 1-4, wherein the information about the participation includes a score for the employee based on at least one of a number of items posted by the employee, a type of each of the items posted by the employee, a status of each of the items posted by the employee, and an amount of input provided by the employee to items not posted by the employee.

### Embodiment 6

The method of any of Embodiments 1-5, wherein the method further comprises providing the information about the participation to an employee recognition system.

### Embodiment 7

The method of any of Embodiments 1-6, wherein the review includes a plurality of stages including a current stage and the method further comprises generating a report that specifies the current stage of the item.

### Embodiment 8

The method of any of Embodiments 1-7, wherein the method further comprises generating a report based on the information about the participation.

### Embodiment 9

A computer program product for dynamically driving innovation. The computer program product comprises a storage medium embodied with computer-readable program instructions which, when executed by a computer, cause the computer to implement any of Embodiments 1-8.

### Embodiment 10

A system for dynamically driving innovation. The system comprises a computer processor and logic executable by the computer processor, the logic configured to implement any of Embodiments 1-8.

### Embodiment 11

A method for dynamically driving innovation, the method comprising: receiving information about employee participation in posting and supplementing items in a dynamic knowledge database, the supplementing items including adding comments. The method also comprises calculating a score for an employee based on the received information and on performance metrics for the employee, the performance metrics including a component for measuring a number of items posted by the employee and a number of comments added by the employee to items posted by other employees. The method further comprises comparing the calculated score to a target score for the employee, and outputting results of the comparing to an employee recognition system.

### Embodiment 12

The method of Embodiment 11, wherein the results of the comparing are output to an employee evaluation system.

### Embodiment 13

The method of any of Embodiments 11-12, wherein the information about the participation includes at least one of a number of items posted by the employee, a type of each of the items posted by the employee, a status of each of the items posted by the employee, and an amount of supplementing provided by the employee to items not posted by the employee.

### Embodiment 14

The method of any of Embodiments 11-13, wherein the method further comprises modifying at least one of the performance metrics and the target score for the employee.

### Embodiment 15

The method of any of Embodiments 11-14, wherein the received information includes information about employees associated with a department; and the method further comprises: calculating a score for the department based on the received information and on performance metrics for the department, comparing the calculated score for the department to a target score for the department, and outputting results of the comparing the calculated score for the department to the target score for the department.

### Embodiment 16

The method of Embodiment 15 further comprising modifying at least one of the performance metrics and the target score for the department.

### Embodiment 17

A computer program product for dynamically driving innovation. The computer program product comprises a storage medium embodied with computer-readable program instructions which, when executed by a computer, cause the computer to implement any of Embodiments 11-16.

### Embodiment 18

A system for dynamically driving innovation. The system comprises a computer processor and logic executable by the computer processor, the logic configured to implement any of Embodiments 11-16.

As described above, the invention can be embodied in the form of computer implemented processes and apparatuses for practicing those processes. An embodiment of the invention can also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the present application.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

The terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. A method for dynamically driving innovation, the method comprising:
providing access to a database of items related to employee knowledge;
performing life cycle management of items in the database, the performing comprising:
receiving an item posted by an employee;
assigning the item a status of draft; and
facilitating a review of the item, the review resulting in the item being accepted or not-accepted based on input from at least one other employee;
tracking participation by the employee and the at least one other employee in the posting and review of the items in the database; and
providing information about the participation to an employee assessment system.

2. The method of claim 1, wherein the at least one other employee is at least one of a manager of the employee and a steering committee expert.

3. The method of claim 1, wherein the items in the database include a description of an idea.

4. The method of claim 1, wherein the items in the database include at least one of an article, a description of a best practice, and a description of a success story.

5. The method of claim 1, wherein the information about the participation includes a score for the employee based on at least one of a number of items posted by the employee, a type of each of the items posted by the employee, a status of each of the items posted by the employee, and an amount of input provided by the employee to items not posted by the employee.

6. The method of claim 1, further comprising providing the information about the participation to an employee recognition system.

7. The method of claim 1, wherein the review includes a plurality of stages including a current stage and the method further comprises generating a report that specifies the current stage of the item.

8. The method of claim 1, further comprising generating a report based on the information about the participation.

9. A method for dynamically driving innovation, the method comprising:
receiving information about employee participation in posting and supplementing items in a dynamic knowledge database, the supplementing items including adding comments;
calculating a score for an employee based on the received information and on performance metrics for the employee, the performance metrics including a component for measuring a number of items posted by the employee and a number of comments added by the employee to items posted by other employees;
comparing the calculated score to a target score for the employee; and
outputting results of the comparing to an employee recognition system.

10. The method of claim 9, wherein the results of the comparing are output to an employee evaluation system.

11. The method of claim 9, wherein the information about the participation includes at least one of a number of items posted by the employee, a type of each of the items posted by the employee, a status of each of the items posted by the employee, and an amount of supplementing provided by the employee to items not posted by the employee.

12. The method of claim 9, further comprising modifying at least one of the performance metrics and the target score for the employee.

13. The method of claim 9, wherein the received information includes information about employees associated with a department and the method further comprises:
calculating a score for the department based on the received information and on performance metrics for the department;
comparing the calculated score for the department to a target score for the department; and
outputting results of the comparing the calculated score for the department to the target score for the department.

14. The method of claim 9, further comprising modifying at least one of the performance metrics and the target score for the department.

15. A computer program product for dynamically driving innovation, the computer program product comprising a storage medium embodied with computer-readable program instructions which, when executed by a computer, cause the computer to implement a method, the method comprising:
providing access to a database of items related to employee knowledge;
performing life cycle management of items in the database, the performing comprising:
receiving an item posted by an employee;
assigning the item a status of draft; and
facilitating a review of the item, the review resulting in the item being accepted or not-accepted based on input from at least one other employee;
tracking participation by the employee and the at least one other employee in the posting and review of the items in the database; and
providing information about the participation to an employee assessment system.

16. The computer program product of claim 15, wherein the items in the database include a description of an idea, an article, a description of a best practice, and a description of a success story.

17. The computer program product of claim 15, wherein the information about the participation includes a score for the employee based on at least one of a number of items posted by the employee, a type of each of the items posted by the employee, a status of each of the items posted by the employee, and an amount of input provided by the employee to items not posted by the employee.

18. The computer program product of claim 15, wherein the method further comprises generating a report based on the information about the participation.

19. (canceled)

20. (canceled)

21. The computer program product of claim 15, wherein the method further comprises providing the information about the participation to an employee recognition system.

22. The computer program product of claim 15, wherein the review includes a plurality of stages including a current stage and the method further comprises generating a report that specifies the current stage of the item.
